(19) United States
(12) Patent Application Publication
(10) Pub. No.: US 2025/0292677 A1
(43) Pub. Date: Sep. 18, 2025

(54) STOP LIGHT SYSTEM

(71) Applicant: Duck Sil YOON, Iksan-si (KR)

(72) Inventor: Duck Sil YOON, Iksan-si (KR)

(21) Appl. No.: 19/015,103

(22) Filed: Jan. 9, 2025

(30) Foreign Application Priority Data
Mar. 13, 2024 (KR) 10-2024-0035325

(51) Int. Cl. G08G 1/07; G08G 1/095

(52) U.S. Cl. CPC G08G 1/07; G08G 1/095

(57) ABSTRACT

A stop light system according to an embodiment of the present invention includes: a traffic light which includes a plurality of consecutive LEDs, and illuminates or extinguishes the LEDs to output signal information; and a signal control server which generates control signals including the illumination and extinguishing of each LED of the traffic light, wherein the traffic light controls the illumination and extinguishing of each LED based on the control signals received from the signal control server. The traffic light includes the plurality of LEDs divided into sections numbered 1 to 10, and each of the plurality of LEDs is arranged adjacently.

### CROSS-REFERENCE TO RELATED APPLICATION

This application claims the benefit of and priority to Korean Patent Application No. 10-2024-0035325 filed on Mar. 13, 2024, which are herein incorporated by reference in its entirety.

### TECHNICAL FIELD

The present disclosure relates to a stop light system, and more specifically, to a stop light system that sequentially adjusts colors of multiple LEDs based on the remaining signal time to enable drivers to anticipate signal change points, thereby reducing traffic accidents and casualties caused by traffic signal violations.

### TECHNICAL BACKGROUND

Unless otherwise indicated, the contents described in this section are not prior arts regarding the claims of the present disclosure and should not be construed as prior arts merely by being included in this section.

Accidents caused by traffic signal violations during driving occur frequently. Among traffic accidents, those caused by traffic signal violations are accidents of a very common type. Accidents can occur due to traffic signal violations in various situations, such as crossing the pedestrian crosswalk without stop when the traffic light turns red, attempting a right turn at an intersection, or trying to make a left turn even when the left-turn signal is red. Such traffic signal violations are violations of traffic rules, which are set to ensure safety during driving, can lead to numerous accidents. Accidents caused by traffic signal violations are more likely to occur at intersections with a plurality of lanes. Collisions between a signal violator and other vehicles often result in severe consequences, including loss of life and property damage.

Additionally, drivers have likely experienced noticing their vehicle entering the crosswalk after crossing the stop line and then reversing to return from the stop line. Furthermore, drivers may have likely hesitated since being unsure whether to stop or proceed when the yellow warning light suddenly turned red. Such moments, particularly when signals transition (e.g., green to yellow or yellow to red), can confuse drivers and make it difficult to make prompt driving decisions, increasing the likelihood of accidents. However, since the current signaling system does not provide a mechanism for drivers to anticipate signal changes, it often makes the drivers unprepared or confused during signal transitions, causing to traffic accidents.

### PATENT LITERATURE

### Patent Documents

Patent Document 1: Korean Patent Publication No. 10-2018-0010003 (Published on Jan. 30, 2018)
Patent Document 2: Korean Patent Publication No. 10-2024-0000232 (Published on Jan. 2, 2024)

### SUMMARY OF THE INVENTION

Accordingly, the present disclosure has been made to solve the above-mentioned problems occurring in the prior arts, and it is an objective of the present disclosure to provide a stop light system including traffic lights with LEDs divided into sections and numbered from 1 to 10, which are initially illuminated, and then are sequentially turned off one by one. Once all the LEDs are turned off, LEDs of a different color are all illuminated again, enabling drivers to predict signal changes through the traffic lights.

Additionally, in the embodiment, the stop light system provides various forms of LEDs and sequentially controls each of the plurality of LEDs included in the traffic lights to provide signal information to drivers, allowing the drivers to adequately predict the timing of signal changes.

However, the objectives to be achieved through the embodiment are not limited to the aforementioned features.

To accomplish the above object, according to the present disclosure, there is provided a stop light system including: a traffic light which includes a plurality of consecutive LEDs, and illuminates or extinguishes the LEDs to output signal information; and a signal control server which generates control signals including the illumination and extinguishing of each LED of the traffic light, wherein the traffic light controls the illumination and extinguishing of each LED based on the control signals received from the signal control server.

Moreover, the traffic light includes the plurality of LEDs divided into sections numbered 1 to 10, and each of the plurality of LEDs is arranged adjacently.

Furthermore, the signal control server includes: a memory which stores at least one instruction for sequentially controlling the plurality of LEDs of the traffic light to allow drivers to predict signal changes; and a processor which executes the operation according to the instruction, wherein the processor illuminates green signal on all LEDs, and then, sequentially extinguishes the green signals from LED 1 to LED 10 within a predetermined time.

Furthermore, the processor illuminates the red signal on all LEDs from LED 1 to LED 10 immediately after green signal of the last LED, LED 10, is extinguished.

Additionally, when the green signal is illuminated on the traffic light, the processor displays the remaining signal time as a numeric value on each of the LEDs from LED 1 to LED 10 and sequentially extinguishes the LEDs from LED 1 to LED 10. Alternatively, the processor sequentially extinguishes the LEDs from LED 1 to LED 9, extinguishes the last LED 10 after a specified number of times of blinking, and then, illuminates the red signal on the LEDs after the LED 10 is extinguished.

In addition, the processor calculates the illumination timing and extinguishing timing of each LED of the traffic lights based on locations of traffic lights, and the surrounding traffic conditions at the location of each traffic light.

Furthermore, the plurality of LEDs are configured such that each LED is connected to the side of the next LED to form a rectangular shape wider horizontally than vertically. Alternatively, if the traffic light includes circular LEDs with a predetermined size or more, the circular LED area is divided into a plurality of sections like a target, and the divided LED sections are set in a specific extinguishing sequence.

As described above, according to the present disclosure, the stop light system sequentially controls the LEDs configured in the traffic lights, allowing drivers to accurately predict signal changes. So, the stop light system enables drivers to better grasp the timing of signal changes and respond appropriately, thereby preventing traffic accidents at intersections.

Additionally, the stop light system according to the embodiment of the present disclosure provides signals using various forms of LEDs to ensure that signals are more clearly visible to drivers, thereby aiding drivers in recognizing and understanding the signals effectively.

In addition, the stop light system according to the embodiment of the present disclosure enhances drivers' ability to perceive and predict signal changes, thereby improving traffic safety. Clearer signal information enables drivers to respond appropriately, thereby reducing traffic accidents and associated casualties.

The effects of the present disclosure are not limited to those mentioned above, and encompass all effects inferable from the configuration of the present disclosure as described in the detailed description or the claims.

### BRIEF DESCRIPTION OF DRAWINGS

FIG. 1 is a view illustrating a stop light system according to an embodiment of the present disclosure.

FIGS. 2 and 3 are views illustrating examples of traffic light configurations according to an embodiment of the present disclosure.

FIG. 4 is a block diagram of a signal control server according to an embodiment of the present disclosure.

### DETAILED DESCRIPTION OF INVENTION

Hereinafter, referring to the attached drawings, specific embodiments will be illustrated in the drawings and described in detail. With reference to the accompanying drawings, like elements are referenced by like reference numerals or signs regardless of the drawing numbers and description thereof is not repeated. The suffixes “module” and “unit” used for the components in the description below are used interchangeably or for convenience in drafting and do not imply distinct meanings or functions. Additionally, detailed descriptions of known technologies related to the embodiments of the present disclosure may be omitted if they are deemed to obscure the gist of the disclosed embodiments. In addition, the attached drawings are provided solely to aid in understanding the embodiments of the present disclosure, but do not limit the technical spirit of the present disclosure as disclosed in this specification. Therefore, it should be understood that all modifications, equivalents, and substitutes within the scope and spirit of the present disclosure are considered included.

Terms such as “first” and “second,” used with ordinal numbers, may be used to describe various components but do not limit the components to the terms. The terms are used solely to distinguish one component from another.

It will be understood that when a component is referred to as being “coupled” or “connected” to another component, it can be directly coupled or connected to the other component or intervening components may be present therebetween. In contrast, it should be understood that when a component is referred to as being “directly coupled” or “directly connected” to another component, there are no intervening components present. Other expressions that explain the relationship between components, such as “between,” “directly between,” “adjacent to,” or “directly adjacent to,” should be construed in the same way.

It will be understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

In this specification, the term “unit” includes a unit implemented through hardware, a unit implemented through software, or a unit implemented through a combination of both. Moreover, a single unit may be realized using multiple hardware components, or multiple units may be realized using a single hardware component.

Operations or functions described as being performed by a terminal, an apparatus, or a device in this specification may, in some cases, be performed by a server connected to the terminal, the apparatus, or the device. Likewise, some operations or functions described as being performed by a server may be performed by a terminal, an apparatus, or a device connected to the server.

Hereafter, the present disclosure will be described in detail with reference to the accompanying drawings.

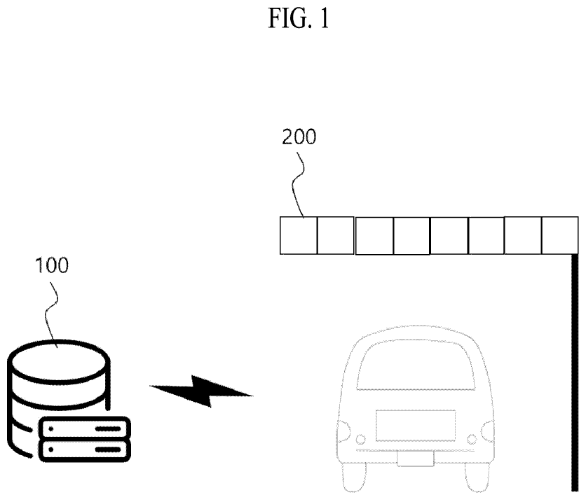

FIG. 1 is a view illustrating a stop light system according to an embodiment of the present disclosure.

Referring to FIG. 1, the stop light system according to the embodiment may include a traffic light 200 and a signal control server 100. In the embodiment, the traffic light 200 includes a plurality of LEDs which illuminate or extinguish green or red light to output signal information. The signal control server 100 generates control signals which include the emission and extinguishing of each LED of the traffic light. In the embodiment, the traffic light 200 in the embodiment controls the emission and extinguishing of each LED based on the control signals received from the signal control server.

The stop light system according to the embodiment includes LEDs divided into sections and numbered from 1 to 10 on the traffic light. After illuminating all the LEDs, the LEDs are sequentially extinguished. Thereafter, when all the LEDs are extinguished, LEDs of a different color are re-illuminated, enabling drivers to predict signal changes through the traffic light.

Additionally, the stop light system in the embodiment provides various forms of LEDs, sequentially controls the plurality of LEDs included in the traffic light to provide signal information to the drivers, allowing the drivers to sufficiently predict signal change timings.

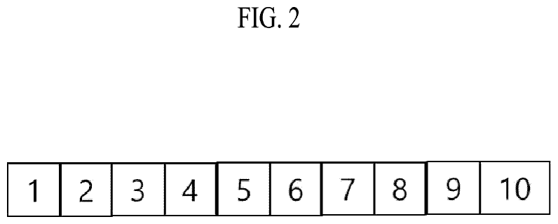

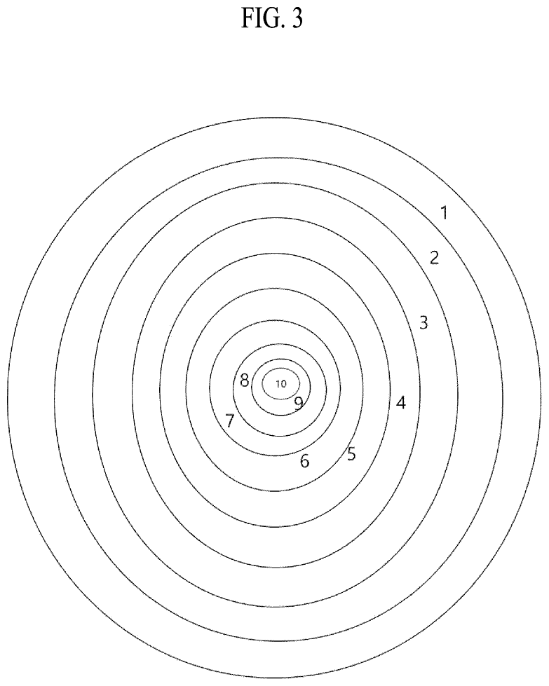

FIGS. 2 and 3 are views illustrating examples of traffic light configurations according to an embodiment of the present disclosure.

Referring to FIG. 2, the traffic light in the embodiment includes a plurality of LEDs divided into sections and numbered from 1 to 10, which may be arranged adjacently. As illustrated in FIG. 2, the traffic light includes a plurality of LEDs, and the plurality of LEDs may be connected on sides of the LEDs to form a rectangular shape that is wider horizontally than vertically. Furthermore, as illustrated in FIG. 3, the traffic light in the embodiment divides a circular LED area into sections resembling a target, the divided LED sections are set in a specific extinguishing sequence.

Referring to FIG. 2, the signal control server 100 in the embodiment illuminates all LED areas of the rectangular shape in green and sequentially extinguishes the green signals from LED 1 to LED 10. After the green signal on LED 10 is extinguished, red signals may be illuminated on all LEDs from LED 1 to LED 10. The red signals are extinguished sequentially from LED 1 to LED 10. Thereafter, once the red signal on LED 10 is extinguished, green signals may be re-illuminated on all LEDs. The above method may also be applied to the target-shaped traffic light illustrated in FIG. 3.

Referring to FIG. 3, when the stop light system according to the embodiment of the present disclosure is applied to the existing traffic light configuration, the circular traffic light area is divided into sections like a target and numbered from 1 to 10. All LED areas included in the target-shaped configuration are illuminated in green, and the green signals are sequentially extinguished from LED 1 to LED 10. After the green signal on LED 10 is extinguished, red signals may be illuminated on all LEDs from LED 1 to LED 10. The red signals are extinguished sequentially from LED 1 to LED 10, when the red signal on LED 10 is extinguished, green signals may be re-illuminated on all LEDs.

Therefore, drivers can adjust the speed of their vehicles from a distance to recognize the signals, and stop accurately at desired positions. Additionally, the drivers can make quick decisions to stop or proceed by predicting the transition timing from green to red or from red to green signals, thereby preventing collisions with vehicles in front or behind.

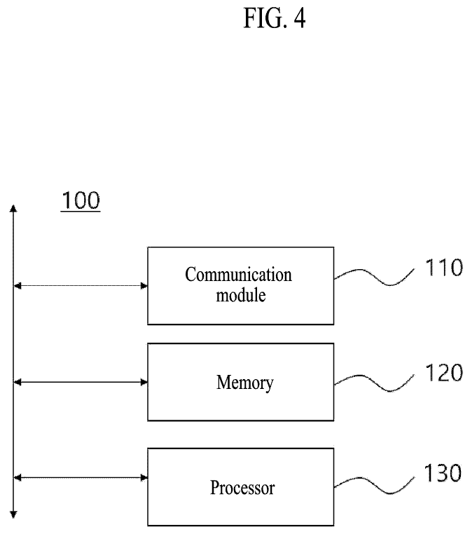

FIG. 4 is a block diagram of a signal control server according to an embodiment of the present disclosure.

In the embodiment, a server is a computing system which provides services or stores and manages data for other computers or devices in a computer network. The server 200 accepts requests from other computers or devices, which are referred to as clients, and provides responses or data for the requests. The configuration of the signal control server 100 illustrated in FIG. 4 is a simplified example.

The communication module 110 can be configured regardless of the communication type, such as wired or wireless, and can be configured as various communication networks, including personal area networks (PAN) and wide area networks (WAN). Additionally, the communication module 110 can operate based on world wide web (WWW) and utilize short-range wireless transmission technologies such as infrared data association (IrDA) or Bluetooth. For instance, the communication module 110 may handle the transmission and reception of data necessary for performing techniques according to an embodiment of the present disclosure.

A memory 120 can refer to any type of storage medium. For example, the memory 120 can include one or more types of storage media, such as flash memories, hard disks, multimedia card micro types, card-type memories (e.g., SD or XD memories), random access memories (RAMs), static random access memories (S RAMs), read-only memories (ROMs), electrically erasable programmable read-only memories (EEPROMs), programmable read-only memories (PROMs), magnetic memories, magnetic disks, and optical disks. The memory 120 may also constitute a database illustrated in FIG. 1.

The memory 120 can store at least one instruction executable by the processor 130. Moreover, the memory 120 can store any form of information generated or determined by the processor 130, as well as any form of information received by the server 200. For example, the memory 120 can store RM data and RM protocols depending on a user, as will be described later. Additionally, the memory 120 can store various types of modules, instruction sets, or models.

The processor 130 can perform the technical features according to the embodiments of the present disclosure described below by executing at least one instruction stored in the memory 120. In one embodiment, the processor 130 can be configured with at least one core, and may include processors for data analysis and/or processing, such as a central processing unit (CPU), a general-purpose graphics processing unit (GPGPU), or a tensor processing unit (TPU).

In the embodiment, the processor 130 generates control signals which include the emission and extinguishing of each LED configured in the traffic light. The processor 130 loads the total illumination time of the green or red signals, divides the total illumination time by the number of LEDs of the traffic light, and calculates the extinguishing time for each LED. Thereafter, the LEDs are sequentially extinguished at the calculated time, and signals of a different color are illuminated on all LEDs. For example, if the total illumination time for the red signal is 100 seconds and there are 10 LEDs, the first LED will be extinguished after ten seconds of illumination, and the second LED will be extinguished after 20 seconds of illumination. After 100 seconds, when the 10th red LED is extinguished, the processor 130 illuminates green signals on all LEDs and sequentially extinguishes the green signals from LED 1 to LED 10 within the designated time. For instance, if the total illumination time for the green signal is 50 seconds, the processor 130 divides 50 seconds by 10 LEDs to calculate the extinguishing time for each LED. In the embodiment, LED 1 is extinguished at the five-second mark, LED 2 at the ten-second mark, and LED 3 at the fifteen-second mark.

Additionally, the processor 130 illuminates red signals on the LEDs numbered from 1 to 10 immediately after the 10th green signal LED is extinguished, repeating the aforementioned illumination and extinguishing operations for the traffic light.

Furthermore, in the embodiment, the processor 130 displays the remaining signal time as a numeric value on the LEDs numbered from 1 to 10, extinguishing the LEDs in sequence. The last 10th LED blinks a specified number of times before being extinguished.

After the 10th LED is extinguished, red signal is illuminated. The processor 130 sets and updates the time for each LED, and it means changing the state of the LEDs according to the remaining signal time. Additionally, the processor 130 can display the remaining signal time as a numeric value for LEDs numbered from 1 through 9, meaning the signal illumination remaining time for each LED as a numeric value. Moreover, the 10th LED blinks a specified number of times before being extinguished, and then is extinguished. After the 10th LED is extinguished, red signal is displayed on all LEDs of the traffic light. When the final LED blinks, the processor 130 calculates the blinking duration for the last LED at a predetermined proportion of the total illumination time for each LED, and can calculate the blinking start time, blinking frequency, and blinking cycle of the last LED using the calculated time.

Additionally, the processor 130 calculates the illumination and extinguishing timing of each LED in the traffic lights based on the respective locations of the traffic lights and the surrounding traffic conditions at the locations. To achieve the above, the processor 130 collects monitoring data transmitted from cameras and CCTVs installed on the traffic lights and detects surrounding traffic volume, vehicle positions, and pedestrian signals using the monitoring data. Thereafter, the processor 130 analyzes the received data to determine the timing for illuminating and extinguishing the LEDs for each traffic light. In the embodiment, the processor 130 can set the illumination duration and cycle of the signals for the traffic lights according to programmed traffic signal scenarios. For instance, based on the analysis of monitoring data, if vehicles are detected on a main road at an intersection, the processor 130 can change the signals for vehicles and pedestrians in other directions. Thereafter, the processor 130 controls output pins to turn the LEDs on and off according to the determined signal timings.

As described above, according to the present disclosure, the stop light system sequentially controls the LEDs configured in the traffic lights, allowing drivers to accurately predict signal changes. So, the stop light system enables drivers to better grasp the timing of signal changes and respond appropriately, thereby preventing traffic accidents at intersections.

Additionally, the stop light system according to the embodiment of the present disclosure provides signals using various forms of LEDs to ensure that signals are more clearly visible to drivers, thereby aiding drivers in recognizing and understanding the signals effectively.

In addition, the stop light system according to the embodiment of the present disclosure enhances drivers' ability to perceive and predict signal changes, thereby improving traffic safety. Clearer signal information enables drivers to respond appropriately, thereby reducing traffic accidents and associated casualties.

The disclosed content is merely illustrative, and various modifications and changes can be made by those skilled in the art without departing from the scope of the claims. Therefore, the protective scope of the present disclosure is not limited to the specific embodiments described above.

What is claimed is:

1. A stop light system comprising:
a traffic light which includes a plurality of consecutive LEDs, and illuminates or extinguishes the LEDs to output signal information; and
a signal control server which generates control signals including the illumination and extinguishing of each LED of the traffic light,
wherein the traffic light controls the illumination and extinguishing of each LED based on the control signals received from the signal control server.

2. The stop light system according to claim 1,
wherein the traffic light includes the plurality of LEDs divided into sections numbered 1 to 10, and each of the plurality of LEDs is arranged adjacently.

3. The stop light system according to claim 1,
wherein the signal control server comprises:
a memory which stores at least one instruction for sequentially controlling the plurality of LEDs of the traffic light to allow drivers to predict signal changes; and
a processor which executes the operation according to the instruction,
wherein the processor illuminates green signal on all LEDs, and then, sequentially extinguishes the green signals from LED 1 to LED 10 within a predetermined time.

4. The stop light system according to claim 3,
wherein the processor illuminates the red signal on all LEDs from LED 1 to LED 10 immediately after green signal of the last LED, LED 10, is extinguished.

5. The stop light system according to claim 3,
wherein when the green signal is illuminated on the traffic light, the processor displays the remaining signal time as a numeric value on each of the LEDs from LED 1 to LED 10 and sequentially extinguishes the LEDs from LED 1 to LED 10, or
wherein the processor sequentially extinguishes the LEDs from LED 1 to LED 9, extinguishes the last LED 10 after a specified number of times of blinking, and then, illuminates the red signal on the LEDs after the LED 10 is extinguished.

6. The stop light system according to claim 1,
wherein the processor calculates the illumination timing and extinguishing timing of each LED of the traffic lights based on locations of traffic lights, and the surrounding traffic conditions at the location of each traffic light.

7. The stop light system according to claim 2,
wherein the plurality of LEDs are configured such that each LED is connected to the side of the next LED to form a rectangular shape wider horizontally than vertically, or
wherein if the traffic light includes circular LEDs with a predetermined size or more, the circular LED area is divided into a plurality of sections like a target, and the divided LED sections are set in a specific extinguishing sequence.
